(19) United States
(12) Patent Application Publication
(10) Pub. No.: US 2010/0111005 A1
(43) Pub. Date: May 6, 2010

(54) APPARATUS AND METHOD FOR TRANSMITTING UPLINK SIGNALS IN A WIRELESS COMMUNICATION SYSTEM

(75) Inventors: Jae-Hyun Ahn, Seoul (KR); Kuk-Jin Song, Gyeonggi-do (KR); Jae-Hyeong Kim, Seoul (KR)

Correspondence Address: AMPACC Law Group, 3500 188th Street S.W., Suite 103, Lynnwood, WA, 98037, US

(73) Assignee: POSDATA CO., LTD., Gyeonggi-do (KR)

(21) Appl. No.: 12/521,778

(22) PCT Filed: Dec. 21, 2007
(86) PCT No.: PCT/KR07/06764

§ 371 Date: Jun. 29, 2009

(30) Foreign Application Priority Data
Dec. 31, 2006 (KR) 10-2007-0139231
May 11, 2007 (KR) 10-2007-0046213

(51) Int. Cl. H04W 72/00

(52) U.S. Cl. 370/329

(57) ABSTRACT

The present invention relates to an apparatus and method for transmitting uplink signals in a wireless telecommunication system. According to the present invention, it is characterized that at least one uplink signal is allocated to other symbol duration for time dispersion in case a plurality of uplink signals are scheduled to be allocated to the same symbol duration of the uplink frame that the terminal transmits to the base station. Accordingly, the terminal can enhance the power spectral density of the uplink signal and the error rate can be reduced.

### TECHNICAL FIELD

The present invention relates to an apparatus and method for transmitting uplink signals in a wireless telecommunication system, more particularly, to an apparatus and method for time-divisionally transmitting control signals of uplink frame that a terminal transmits to a base station in an OFDMA wireless telecommunication system.

### BACKGROUND ART

The portable internet system like the mobile WiMAX is capable of providing the high speed data service when a user moves in a radio environment. Additionally, it can simultaneously provide internet service to multi-users by using the OFDMA (Orthogonal Frequency Division Multiple Access) with a multiple access mode. Additionally, by using the TDD (Time Division Duplexing) with dual mode, which divides the downlink and the uplink according to time, the two-way communication between the terminal and the base station can be available.

FIG. 1 exemplifies the frame structure which is used in a portable Internet system based on the IEEE 802.16d/e. As shown in FIG. 1, one frame is divided into the downlink frame (DL Frame) that the base station transmits to the terminal and the uplink frame (UL Frame) that the terminal transmits to the base station. And, the two-way communications is performed through them. In the illustrated example, the uplink frame includes a control channel and an uplink burst, while the control channel is used as the ranging channel, the CQI (Channel Quality Indicator) channel, and the ACK (Acknowledgement) channel.

In the meantime, in contrast with the station, the terminal uses a limited power due to the mobility. Hence, the intensity of the uplink signal which each terminal transmits is limited by the maximum subchannel number allocated to each symbol duration. For example, assuming that the terminal transmits the uplink burst by using the usable maximum power during the unit symbol duration, the power spectral density PSD becomes lower when two subchannels are used than one subchannel is used in the same symbol duration.

FIG. 2 shows the case in which each terminal (terminal a˜terminal d) transmits the uplink signal (uplink burst) with different numbers of subchannels. Here, it is shown that the power spectral density of the uplink signal which each terminal transmits is changed according to the maximum number of subchannels allocated to each symbol duration. For reference, the power spectral density indicates the electric power per unit frequency, which means the value dividing the total power which the terminal used by the total frequency band that the corresponding terminal used for the unit symbol duration, while the unit is W/Hz.

In detail, the terminal a transmits signals by using one subchannel (Subchannel #1) during four consecutive symbol duration (Symbol #1˜#4), and the power spectral density is 20 mW/(8.75 mhz/30) (here, it is assumed that the maximum power that each terminal can use during the unit symbol duration is 20 mW). The terminal b transmits signals by using one subchannel (Subchannel #2) during two symbol duration (Symbol #1, #2), while the power spectral density is also 20 mW/(8.75 mhz/30). However, the terminal c transmits signals by using two subchannels (Subchannel #2, #3) in a specific symbol duration(Symbol #3), thereby, it has the power spectral density of 10 mW/(8.75 mhz/30) which is a half of the power spectral density of other terminal.

In the meantime, in case of the terminal d, although signals are transmitted by using two subchannels (Subchannel #3, #4), it is allocated to a different symbol duration. Hence, the subchannel is not overlapped in each symbol. Thus, the power spectral density becomes 20 mW/(8.75 mhz/30). In this way, the power spectral density of the uplink signal is changed according to the maximum number of subchannels allocated to each symbol duration.

However, the reduction of the power spectral density increases the error rate of the transmission signal. Particularly, this causes the problem that such error largely affects to the control signal transmitted through the control channel. Therefore, a new technique in which one terminal transmits the control signal without being overlapped in the same time slot as long as possible is required.

### DISCLOSURE OF INVENTION

### Technical Problem

The invention has been designed to solve the above-mentioned problems, and it is an object of the invention to provide an apparatus and method for time-divisionally transmitting the uplink frame which a terminal transmits to a base station in a wireless telecommunication system in order that subchannels of a proper number is allocated to each symbol duration.

It is another object of the present invention to provide an apparatus and method for transmitting the uplink frame by time dispersion in order that the control signal having a different kind is not to be allocated to the same symbol duration in the control channel zone of the uplink frame in a wireless telecommunication system.

It is still another object of the present invention to provide an apparatus and method for transmitting the uplink signals by time dispersion in order that the terminal has the power spectral density as high as possible when the terminal transmits the uplink signals to the base station.

It is still another object of the present invention to provide an apparatus and method for dispersedly transmitting the uplink signals by controlling the maximum number of subchannels allocated to the unit symbol duration according to the residual electric power of the terminal when the terminal transmits the uplink signals to the base station.

### Technical Solution

In order to achieve the above objects, according to an aspect of the invention, there is provided an apparatus for transmitting uplink signals in a wireless telecommunication system, which comprises signal allocating means for checking control signals for transmitting through a control channel of an uplink frame, and, in case a plurality of control signals are scheduled to be allocated to a first symbol duration among symbol duration of the control channel, allocating at least one among the plurality of control signals to a second symbol duration; and signal transmission means for transmitting the control signal in a corresponding symbol duration according to a scheduling scheme allocated by the signal allocating means.

According to another aspect of the invention, there is provided an apparatus for transmitting uplink signals in a wireless telecommunication system, which comprises signal allocating means for checking uplink signals which are scheduled to be allocated to each symbol duration of an uplink frame, and, in case the number of subchannels of the uplink signals which are scheduled to be allocated to a first symbol duration among the symbol duration exceeds a preset threshold, allocating at least one uplink signal to a second symbol duration to generate a scheduling information; and signal transmission means for transmitting the uplink signals by loading on corresponding subchannels according to the scheduling information.

According to yet another aspect of the invention, there is provided a method for transmitting uplink signals in a wireless telecommunication system, which comprises the steps of: a) checking the number of subchannels which are scheduled to be allocated to each symbol duration of an uplink frame; b) allocating, with respect to a symbol in which the number of the checked subchannels exceeds a preset threshold, a part of the subchannels scheduled to be allocated to the symbol to other symbol; and c) transmitting uplink signals through the allocated subchannels.

According to still another aspect of the invention, there is provided a method for transmitting uplink signals in a wireless telecommunication system, which comprises the steps of: a) checking a control signal to be transmitted through a control channel of an uplink frame; b) in case a plurality of control signals are scheduled to be allocated to a first symbol duration among symbols of the control channel, allocating at least one among the plurality of control signals to a second symbol duration; and c) transmitting the allocated control signal.

According to still another aspect of the invention, there is provided a method for transmitting uplink signals in a wireless telecommunication system, which comprises the steps of: a) checking a control signal to be transmitted through a control channel of an uplink frame; b) in case a plurality of control signals are scheduled to be allocated to the same symbol among symbols of the control channel, scheduling the plurality of control signals according to a priority by time dispersion; and c) transmitting a corresponding control signal according to the scheduled order.

### Advantageous Effects

According to the present invention, the transmission power spectral density can be increased by transmitting the uplink signal which the terminal transmits to the base station with time dispersion in order that the uplink signal of proper number is allocated to each symbol duration, thereby, the error rate of the uplink signal can be reduced.

According to the present invention, the uplink signals can be efficiently transmitted dispersedly according to a situation by controlling the maximum number of subchannels which can be allocated to a single symbol duration according to the residual electric power value of a terminal.

Furthermore, according to the present invention, the error rate of the control signal can be decreased by transmitting the control signal through the control channel by time dispersion according to the priority.

### BRIEF DESCRIPTION OF THE DRAWINGS

FIG. 1 is a drawing showing a frame structure which is used in a portable Internet system based on the IEEE 802.16d/e.

FIG. 2 is a drawing showing a power spectral density that each terminal uses for the uplink signal.

FIG. 3 is a drawing illustrating a backoff algorithm used for a contention-based ranging.

FIG. 4 is a drawing showing a slot size for a control channel of different type.

FIG. 5 is a configuration diagram of an apparatus for uplink signal transmitting according to the present invention.

FIG. 6 is a drawing illustrating a control signal allocation scheme according to the present invention, in case the control channel of the uplink frame is formed with three symbols.

FIG. 7 is a drawing illustrating a typical control signal allocation scheme, in case the control channel of the uplink frame is formed with six symbols.

FIGS. 8 and 9 are drawings illustrating a control signal allocation scheme according to the present invention, in case the control channel of the uplink frame is formed with six symbols.

FIG. 10 is a drawing illustrating a control signal allocation scheme according to the present invention, in case the control signal is scheduled to be allocated respectively to the CQI channel region and ACK channel region of the same uplink frame in connection with FIG. 8.

FIG. 11 is a drawing illustrating a control signal allocation scheme according to the present invention, in case the control signal is scheduled to be allocated respectively to the ranging channel region and CQI channel region of the same uplink frame in connection with FIG. 8.

FIGS. 12 and 13 are flowcharts illustrating the method of the uplink signal transmission according to the present invention.

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

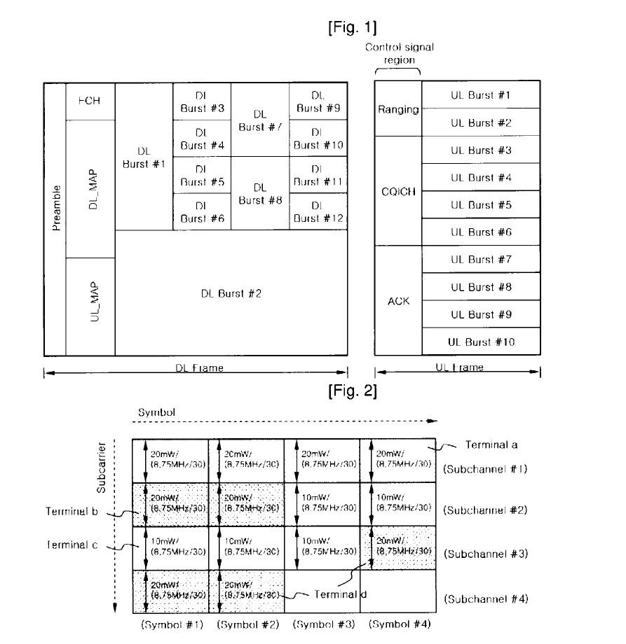

Firstly, before describing the configuration of the present invention in detail, the control channel which is included in an uplink frame will be illustrated. As shown in FIG. 1, the control channel is usually positioned in the beginning part of the uplink frame, and includes a CDMA ranging channel, a CQI channel, and an ACK channel.

The CDMA ranging channel is used for an initial ranging, a hand-off ranging, a periodic ranging, and a bandwidth request ranging. The initial ranging is performed for the system channel and the synchronous acquisition when the terminal connects to a network for the first time. The hand-off ranging is performed when a hand-off is processed from a serving base station to a target base station. The periodic ranging is periodically performed in order that the terminal is capable of the synchronization tracing. The bandwidth request ranging is performed when the terminal requires the base station of a bandwidth. In case the terminal is unable to succeed in a ranging, the connection between the base station and the terminal may be disconnected or a proper resource allocation may not be performed. In this case, the terminal can waste time for the reconnection with the base station.

In the meantime, when the ranging is classified according to mode, it can be divided into a message-based ranging and a contention-based ranging. However, since the message-based ranging is not allocated to the control channel region, hereinafter, the contention-based ranging will be illustrated.

In the present embodiment, the contention-based ranging uses CDMA and a backoff algorithm. When the terminal performs the contention-based ranging, the terminal selects one code in a pre-defined code set of downlink channel descriptor DCD at random, and selects one number in a backoff window range at random. These are selected with the same probability respectively. The selected code becomes the ranging code, while the selected number becomes the backoff number. After deferring the slots corresponding to the backoff number, the terminal transmits the ranging code in the next slot.

The region (ranging region) for the CDMA contention-based ranging is comprised of slots. Here, the slot is a unit necessary for transmitting one CDMA code. The size of the slot is changed according to the ranging type. The backoff is performed by the slot. Generally, since the number of backoff is greater than the number of slot of the ranging region included within one frame, the more slots are required for deferring. Hence, after deferring the slots in the ranging region of the current frame, the terminal performs deferring the remained slots in the succeeding frame.

FIG. 3 exemplifies a backoff algorithm when the number of backoff is set as 11.

Referring to FIG. 3, a first frame includes the ranging region consisting of four slots. Accordingly, the deferring is performed for four slots among the total eleven slots, thus, the number of residual slots is seven. A second frame includes the ranging region consisting of six slots, and the deferring is performed for six slots among the residual slots after the first frame, thus, the number of residual slot is one. Finally, a third frame includes the ranging region consisting of three slots, and the deferring is performed for the one residual slot after the second frame. Thereafter the ranging code is transmitted in the next slot of the third frame.

In the meantime, the CQI (Channel Quality Indicator) channel is used when the terminal transmits the status information (DL CINR estimation information) on the downlink channel to the base station. In detail, in case the terminal receives ‘CQICH Allocation IE’ from the base station, the terminal performs the code-based channel quality reporting. The information related to the CQI report is included in the ‘CQICH Allocation IE’, and the terminal transmits the CQI value (CQI code) corresponding to the channel CINR measured from the downlink signal to the base station. In case the CQI code is not correctly transmitted, the base station cannot recognize the state of the downlink channel. Then, the downlink scheduling (DL scheduling) performance of the base station can be lowered.

Finally, the ACK (Acknowledgement) channel is used when the ACK/NACK signal informing whether there is an error of the receipt packet is transmitted to the base station in the system to which the ARQ (Automatic Repeat Request) is applied. The ACK channel is allocated correspondingly to the CID (Connection Identifier). The ACK/NACK message is consecutively mapped to the region which is previously allocated. In case an error is generated in the ACK/NACK signal, the packet can be lost or the loss of the transmission resource can be occurred due to the unnecessary re-transmission.

In the meantime, as shown in FIG. 4, the slot size of the above-described control channels is changed according to the type of the control channel. For example, the slot for the initial ranging and hand-off ranging is formed with two symbols and six subchannels, and the slot for the periodic ranging and bandwidth request ranging is formed with one symbol and six subchannels. The slot of the CQI channel is formed with three symbols and one subchannel. The slot of the ACK channel is formed with three symbols and ½ subchannel.

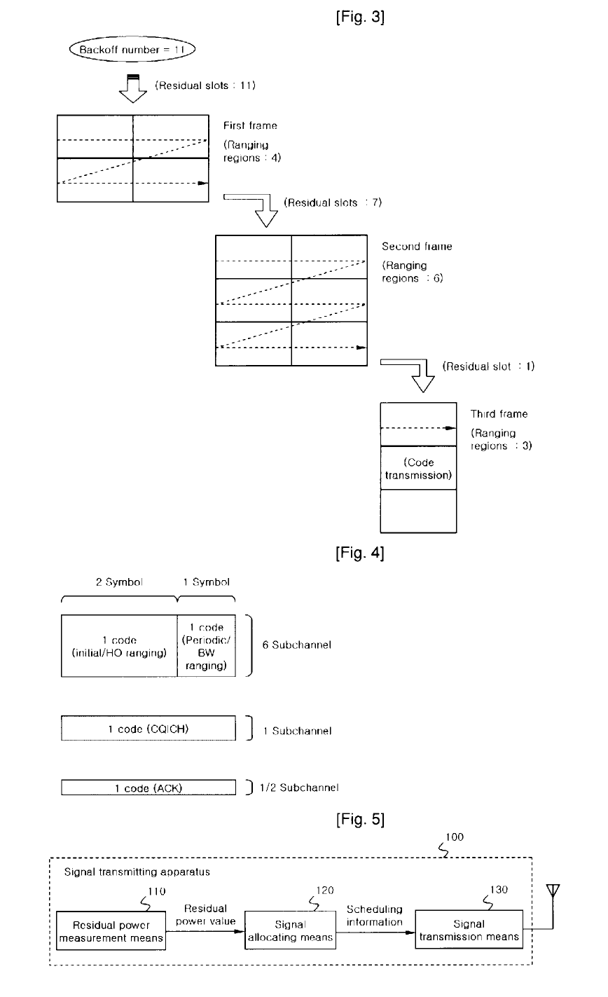

Hereinafter, referring to FIGS. 5 to 13, the apparatus and method for uplink signal transmission according to the present invention will be illustrated in detail.

FIG. 5 is a configuration diagram of a signal transmitting apparatus 100 according to the present invention. As shown, the signal transmitting apparatus includes residual power measurement means 110, signal allocating means 120 and signal transmission means 130.

The residual power measurement means 110 measures the residual electric power of the terminal and transmits to the signal allocating means. The signal allocating means 120 checks the uplink signal (or the subchannel number) scheduled to be allocated to each symbol duration, and allocates at least one signal to other symbol duration in case the excessive uplink signal is scheduled to be allocated to the unit symbol duration.

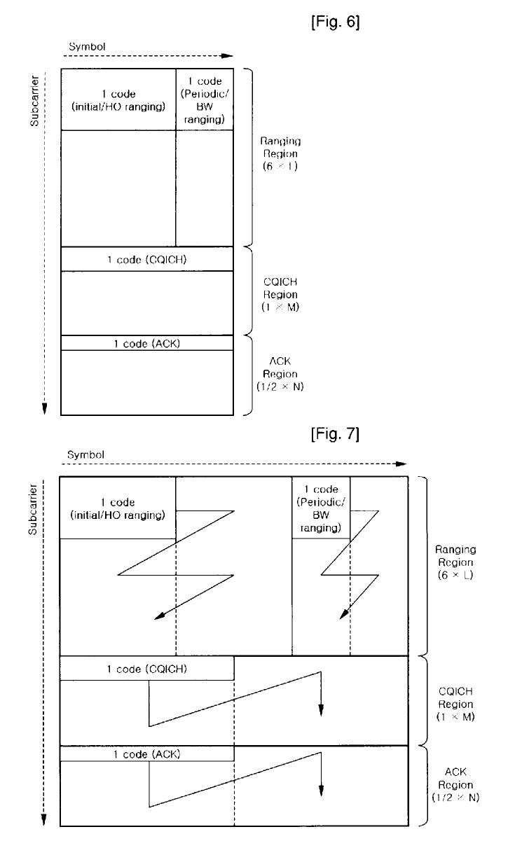

For example, in case the subchannel number scheduled to be allocated to the unit symbol duration exceeds a preset threshold, it allocates at least one uplink signal to other symbol duration for the time dispersion of a signal. Here, the threshold value is a value limiting the maximum subchannel number which can be allocated to the unit symbol duration so as to enhance the power spectral density, which, for example, can be set up with reference to the residual electric power value transmitted from the residual power measurement means 110. Additionally, in case a plurality of control signals are scheduled to be allocated to the same symbol (first symbol) duration among symbols forming the control channel, the signal allocating means 120 can perform the time dispersion of a signal by allocating at least one control signal to other symbol (second symbol) duration. Referring to FIGS. 6 to 11, it will be described in the below in detail. Finally, the signal transmission means 130 transmits the uplink signal by loading on a corresponding subchannel according to the scheduling information (uplink signal allocation information) which is transmitted from the signal allocating means 120.

In the meantime, according to the present invention, the signal allocating means 120 uses a different scheduling algorithm according to the structure of the control channel. Hereinafter, the scheduling method will be illustrated for the case in which the control channel is formed with three symbols and for the case in which the control channel is formed with six symbols.

FIG. 6 is a drawing illustrating a control signal allocation scheme (scheduling method) according to the present invention, in case the control channel of the uplink frame is formed with three symbols.

Referring to FIG. 6, the initial ranging and the hand-off ranging region are formed through the first and second symbol duration of the uplink frame. The periodic ranging and the bandwidth request ranging region are formed in the third symbol duration of the uplink frame. The ranging transmission slot of L (L is a positive integer) can be allocated to the ranging region. In the meantime, the CQI channel region is formed through the initial three symbols of the uplink frame. Here, the CQI transmission slot of M (M is a positive integer) can be allocated. Similarly, the ACK channel region is formed through initial three symbols of the uplink frame. Here, the ACK transmission slot of N (N is a positive integer) can be allocated.

In case the terminal performs the initial ranging or the hand-off ranging, since it is performed in the state in which the uplink synchronization is not secured at all for the network entry, other control signal cannot be transmitted. That is, the initial ranging and hand-off ranging are not simultaneously performed with other control mechanism. Therefore, in this case, the allocating problem of the control signal is not generated.

However, in case of other control signals, one can be simultaneously transmitted to the same symbol duration with other control signal. In this case, the present invention allocates the control signal time-divisionally according to the priority. For example, the CQI signal and ACK signal to which the transmission duration is allocated by the base station have a higher priority than the periodic ranging signal and bandwidth request ranging signal in which the transmission duration is selected by the terminal at random. As to both of the periodic ranging signal and the bandwidth request ranging signal, the priority of the periodic ranging signal is higher. It can be expressed like this.

[The Priority of the Control Signal]

CQI signal, ACK signal>periodic ranging signal>bandwidth request ranging signal

Hence, in case the periodic ranging signal and bandwidth request ranging signal are scheduled to be simultaneously allocated to the current frame (first uplink frame), the bandwidth request ranging is delayed as much as the ranging opportunities of L. Here, L is the number of slots corresponding to the ranging region, accordingly, the bandwidth request ranging is performed in the next frame (second uplink frame) after the deferring the slots of L. In this case, the backoff window size does not become two times, because it does not clashes with the ranging of other terminal.

In case the CQI signal and periodic ranging signal or the bandwidth request ranging signal are scheduled to be simultaneously allocated to the current frame, the periodic ranging or the bandwidth request ranging are performed in the next frame after deferring the slots of L.

Hereinafter, referring to FIGS. 7 to 11, the case in which the control channel of the uplink frame is formed with six symbols will be illustrated.

FIG. 7 is a drawing illustrating a typical control signal allocation scheme, in case the control channel of the uplink frame is formed with six symbols.

Referring to FIG. 7, the initial ranging and hand-off ranging region are formed through the initial four symbol duration of the uplink frame, while the periodic ranging and bandwidth request ranging region are formed in the fifth and the sixth symbol duration of the uplink frame. In the ranging region, the ranging transmission slots of 2L (L is a positive integer) can be allocated. In the ranging region, firstly, the opportunity is allocated for the same subchannel in order of symbol. Then, the opportunity is allocated for the next subchannel in order of symbol after one subchannel is all allocated.

In the meantime, the CQI channel region is formed through the initial six symbol duration of the uplink frame. Here, the CQI transmission slots of 2M (M is a positive integer) can be allocated. Similarly, the ACK channel region is formed through the initial six symbol duration of the uplink frame. Here, the ACK transmission slots of 2N (N is a positive integer) can be allocated. In the CQI channel region and ACK channel region, firstly, the opportunity is all allocated for the initial three symbols in order of subchannel. Then, the opportunity is allocated for the next three symbols in order of subchannel.

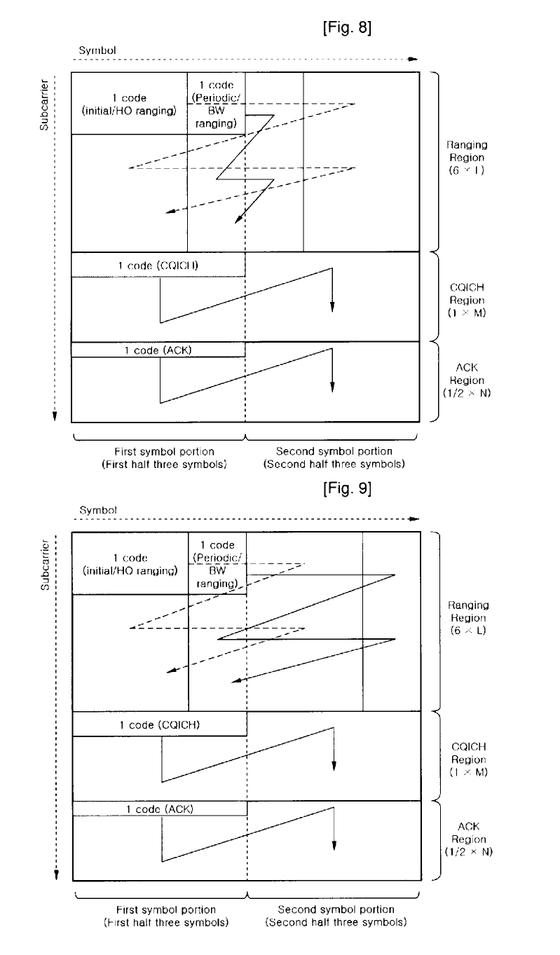

However, in case of FIG. 7, now that the transmission slot of the periodic ranging and the bandwidth request ranging allocated to the fifth or sixth symbol duration of the uplink frame is overlapped with the slot of the CQI channel and/or the ACK channel which is formed in the fourth, the fifth, and the sixth symbol duration of the uplink frame, there is a problem in that the efficient signal allocation is difficult. Thus, the present invention suggests the control channel structure as illustrated in FIGS. 8 and 9.

Hereinafter, referring to FIGS. 8 to 11, the control signal allocation scheme will be illustrated in case the control channel of the uplink frame is formed with six symbols.

Referring to FIGS. 8 and 9, the control channel structure is divided into a first symbol portion (the first half symbol portion) consisting of the initial three symbols and a second symbol portion (the second half symbol portion) consisting of the latter three symbols. The control channel slot of each type can be allocated to both the first symbol portion and the second symbol portion.

In this case, in the ranging region, firstly, the opportunity is allocated for the same subchannel in order of symbol. Then, the opportunity is allocated for the next subchannel in order of symbol after one subchannel is all allocated. In the CQI channel region and ACK channel region, firstly, the opportunity is all allocated for the first symbol portion in order of subchannel. Thereafter, the opportunity is allocated for the second symbol portion in order of subchannel.

In the meantime, the priority of each control signal can be set identically with the case of the three symbols. In this way, the scheduling algorithm is as follows.

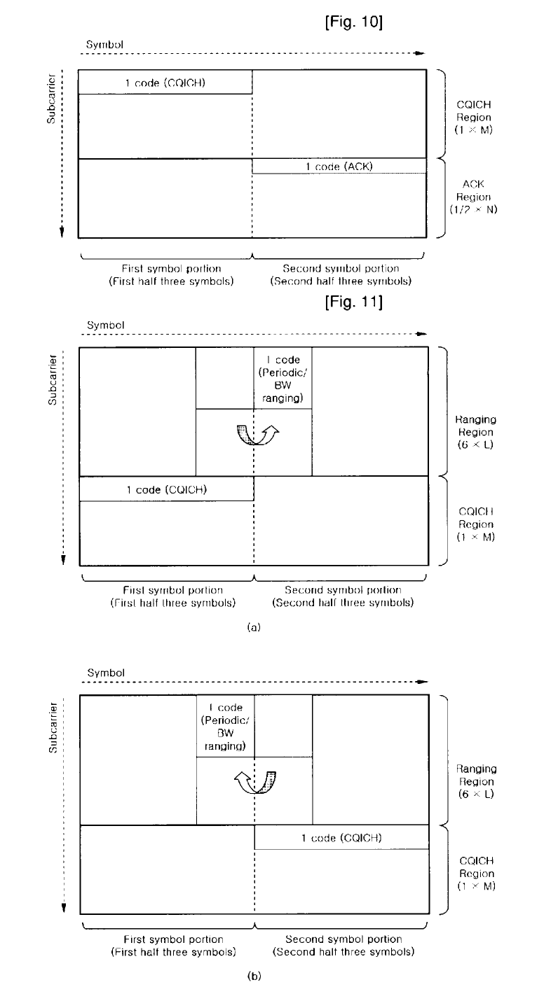

First, in case the CQI signal and the ACK signal are scheduled to be simultaneously allocated to the current frame, the CQI signal and the ACK signal are allocated to a different symbol portion. FIG. 10 shows the time dispersion by allocating the CQI signal to the first symbol portion and allocating the ACK signal to the second symbol portion.

Second, in case the ranging (the periodic ranging, the bandwidth request ranging) signal is scheduled to be allocated to the current frame with the CQI signal and the ACK signal, the ranging backoff is delayed as much as 2L slots to be performed in the next frame.

Third, in case the ranging signal is scheduled to be allocated to the current frame with the CQI signal or the ACK signal, the ranging backoff precedes or is delayed as much as one slot to be allocated in a different symbol portion. It is shown in FIG. 11, and FIG. 11a shows that the ranging signal is delayed as much as one time ranging opportunity to be allocated to the second symbol portion in case the CQI signal and the ranging signal are scheduled to be allocated to the first symbol portion, FIG. 11b shows that the ranging signal precedes as much as one time ranging opportunity to be allocated to the first symbol portion in case the CQI signal and the ranging signal are scheduled to be allocated to the second symbol portion.

Fourth, in case the periodic ranging signal and the bandwidth request ranging signal are scheduled to be simultaneously allocated to the current frame, the bandwidth request ranging signal is delayed as much as 2L slots to be performed in the next frame. Alternatively, the bandwidth request ranging signal precedes or is delayed as much as one time ranging opportunity to be allocated to other symbol portion. Here, in case the CQI signal or the ACK signal is scheduled to be allocated to other symbol portion of the current frame, the bandwidth request ranging signal is delayed as much as 2L slots to be performed in the next frame.

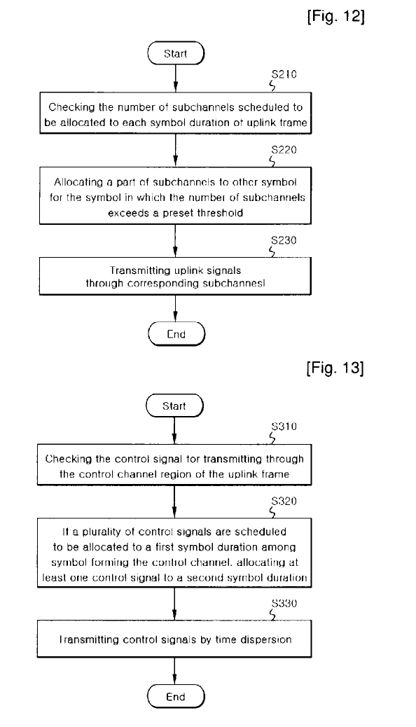

Hereinafter, referring to FIGS. 12 and 13, the signal transmission method according to the present invention will be illustrated. For reference, now that the detailed process or the principles of operation for signal transmission method according to the present invention can refer to the description of the above-described signal transmitting apparatus, the duplicated description will be omitted and the step of time-serially generation will be illustrated.

Firstly, FIG. 12 is a flowchart showing a signal transmission method according to an embodiment of the present invention. At step S210, the terminal checks the number of subchannels which are scheduled to be allocated to each symbol duration of the uplink frame. At step S220, as to a symbol in which the number of the checked subchannels exceeds a preset threshold, the terminal allocates a part of the subchannels scheduled to be allocated to the symbol to other symbol. Here, the threshold can be adjusted according to the residual electric power value of the terminal. Finally, at step S230, the terminal transmits the uplink signal to the base station through the allocated subchannels.

FIG. 13 is a flowchart illustrating the method of signal transmitting with time dispersion according to another embodiment of the present invention.

At step S310, the terminal checks the control signal for transmitting through the control channel region of the uplink frame. At step S320, in case a plurality of control signals are scheduled to be allocated to a first symbol duration among symbols forming the control channel, the terminal allocates at least one among the plurality of control signals to a second symbol duration. In case the plurality of control signals are different kinds of signals, the terminal performs scheduling with time dispersion of the plurality of control signals according to the priority. For example, the control signal which has a relatively low priority among the plurality of control signals is allocated to the second symbol duration.

The priority can be set in sequence of the CQI signal, the periodic ranging signal, and the bandwidth request ranging signal. In case the control signal allocated to the second symbol duration is the periodic ranging signal and/or the bandwidth request ranging signal, the terminal can allocates the periodic ranging signal and/or the bandwidth request ranging signal to the next frame by using the backoff algorithm. Finally, at step S330, the terminal transmits the allocated control signal to the base station.

In the meantime, the method of signal transmitting according to the present invention can be illustrated according to each case in view of the control signal.

First, it is the case in which the periodic ranging signal and the bandwidth request ranging signal are transmitted. In this case, firstly, it is checked whether the preset time points of transmission of the periodic ranging signal and the bandwidth request ranging signal which are to be transmitted through the control channel of a first uplink frame are identical. In case the preset time points of transmission of the control signals are identical, the bandwidth request ranging signal is transmitted through the control channel of a second uplink frame.

Second, it is the case in which the periodic ranging signal, the bandwidth request ranging signal, and the CQI signal are transmitted. In this case, firstly, it is checked whether the preset time points of transmission of the periodic ranging signal, the bandwidth request ranging signal, and the CQI signal which are to be transmitted through the control channel of the first uplink frame are identical. In case the preset time point of transmission of the control signals are identical, the periodic ranging signal and the bandwidth request ranging signal are transmitted through the control channel of the second uplink frame.

Third, it is the case in which the periodic ranging signal, the bandwidth request ranging signal, and the CQI signal or the ACK signal are transmitted. In this case, firstly, it is checked whether the preset time points of transmission of the periodic ranging signal, the bandwidth request ranging signal, and the CQI signal or the ACK signal which are to be transmitted through the control channel of the first uplink frame are identical. In case the preset time point of transmission of the control signals are identical, and the CQI signal or the ACK signal is transmitted from the first half of the CQI channel region or the ACK channel region, the periodic ranging signal and the bandwidth request ranging signal are delayed and transmitted.

On the other hand, in case the preset time points of transmission of control signals are identical, and the CQI signal or the ACK signal is transmitted from the second half of the CQI channel region or the ACK channel region, the periodic ranging signal and the bandwidth request ranging signal precede and transmitted. At this time, the bandwidth request ranging signal can be delayed than the periodic ranging signal to be transmitted.

Fourth, it is the case in which the periodic ranging signal, the bandwidth request ranging signal, the CQI signal, and the ACK signal are transmitted. In this case, firstly, it is checked whether the preset time points of transmission of the periodic ranging signal, the bandwidth request ranging signal, the CQI signal, and the ACK signal which are to be transmitted through the control channel of the first uplink frame are identical. In case the preset time point of transmission of the control signals are identical, the preset time point of transmission of the bandwidth request ranging signal is delayed, and the preset time points of transmission of the bandwidth request ranging signal and the periodic ranging signal are delayed again and transmitted. At this time, it is preferable that the CQI channel region for the CQI signal and the ACK channel region for the ACK signal are allocated in a different time.

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

1. An apparatus for transmitting uplink signals in a wireless telecommunication system, the apparatus comprising:
signal allocating means for checking control signals for transmitting through a control channel of an uplink frame, and, in case a plurality of control signals are scheduled to be allocated to a first symbol duration among symbol duration of the control channel, allocating at least one among the plurality of control signals to a second symbol duration; and
signal transmission means for transmitting the control signal in a corresponding symbol duration according to a scheduling scheme allocated by the signal allocating means,
wherein a plurality of control signals are different kinds of control signals having a priority respectively, wherein the signal allocating means allocates the at least one control signal which has a relatively low priority among the plurality of control signals to a second symbol duration.

2. (canceled)

3. The apparatus of claim 1, wherein, in case a plurality of control signals are scheduled to be allocated to the first symbol duration of the control channel of a first uplink frame, the signal allocating means allocates at least one among the plurality of control signals to the second symbol duration of the control channel of a second uplink frame.

4. The apparatus of claim 1, wherein, in case a plurality of control signals are scheduled to be allocated to the first symbol duration, the signal allocating means allocates at least one among the plurality of control signals to the second symbol duration by using a backoff algorithm.

5. The apparatus of claim 1, wherein, the control channel is formed of a first symbol portion and a second symbol portion which are comprised of the preset number of symbols and can transmit one control signal respectively, wherein, in case a plurality of control signals are scheduled to be allocated to the first symbol duration of the first symbol portion, the signal allocating means allocates at least one among the plurality of control signals to the second symbol duration of the second symbol portion.

6. The apparatus of claim 1, wherein the control channel includes a ranging channel and a CQI channel, wherein, in case the control signals are scheduled to be allocated to a ranging channel region and a CQI channel region of a first uplink frame respectively, the signal allocating means allocates the control signal which is scheduled to be allocated to the ranging channel region of the first uplink frame to the ranging channel region of a second uplink frame.

7. The apparatus of claim 1, wherein the control channel includes a ranging channel, wherein, in case the periodic ranging signal and bandwidth request ranging signal are scheduled to be simultaneously allocated to a ranging channel region of a first uplink frame, the signal allocating means allocates one of the periodic ranging signal and the bandwidth request ranging signal to a ranging channel region of a second uplink frame by using a backoff algorithm.

8. An apparatus for transmitting uplink signals in a wireless telecommunication system, the apparatus comprising:
signal allocating means for checking uplink signals which are scheduled to be allocated to each symbol duration of an uplink frame, and, in case the number of subchannels of the uplink signals which are scheduled to be allocated to a first symbol duration among the symbol duration exceeds a preset threshold, allocating at least one uplink signal to a second symbol duration to generate a scheduling information; and
signal transmission means for transmitting the uplink signals by loading on corresponding subchannels according to the scheduling information,
wherein the first symbol and the second symbol are comprised in a different uplink frame.

9. The apparatus of claim 8, further comprising residual power measurement means for measuring a residual power value of a terminal, wherein the threshold is set according to the residual power value.

10. (canceled)

11. A method for transmitting uplink signals in a wireless telecommunication system, the method comprising the steps of:
a) checking the number of subchannels which are scheduled to be allocated to each symbol duration of an uplink frame;
b) allocating, with respect to a symbol in which the number of the checked subchannels exceeds a preset threshold that is set according to a residual power value of a terminal, a part of the subchannels scheduled to be allocated to the symbol to other symbol; and
c) transmitting uplink signal through the allocated subchannels.

12. (canceled)

13. A method for transmitting uplink signals in a wireless telecommunication system, the method comprising the steps of:
a) checking a control signal to be transmitted through a control channel of an uplink frame;
b) if a plurality of different kinds of control signals are scheduled to be allocated to a first symbol duration among symbols of the control channel, allocating at least one control signal having a relatively low priority among the plurality of control signals to a second symbol duration; and
c) transmitting the allocated control signal.

14. (canceled)

15. The method of claim 13, wherein the plurality of control signals includes a ranging signal, wherein, at step b), the ranging signal is allocated to a second symbol by using a backoff algorithm.

16. A method for transmitting uplink signals in a wireless telecommunication system, the method comprising the steps of:
a) checking a control signal to be transmitted through a control channel of an uplink frame;
b) if a plurality of control signals are scheduled to be allocated to the same symbol among symbols of the control channel, scheduling the plurality of control signals according to a priority by time dispersion; and
c) transmitting a corresponding control signal according to the scheduled order.

17. The method of claim 16, wherein the plurality of control signals includes a CQI signal, a periodic ranging signal, and a bandwidth request ranging signal in sequence of priority.

18. A method for transmitting uplink signals in an OFDMA wireless telecommunication system, the method comprising the steps of:
a) checking whether the preset time points of transmission of a periodic ranging signal and a bandwidth request ranging signal which are to be transmitted through a control channel of a first uplink frame are identical each other; and
b) if the preset time points of transmission are identical, transmitting the bandwidth request ranging signal through a control channel of a second uplink frame.

19. The method of claim 18, wherein the step a) includes the step of
a′) checking whether the preset time point of transmission of a CQI signal is identical with the preset time points of transmission of the periodic ranging signal and the bandwidth request ranging signal, and
wherein, at the step b), if the preset time points of transmission of the periodic ranging signal, the bandwidth request ranging signal and the CQI signal are identical, the periodic ranging signal and the bandwidth request ranging signal are transmitted through the control channel of the second uplink frame.

20. The method of claim 13, wherein the step a) includes the step of
a′) checking whether the preset time points of transmission of a periodic ranging signal, a bandwidth request ranging signal, and a CQI signal or an ACK signal which are to be transmitted through the control channel of the uplink frame are identical; and
wherein the step b) includes the step of
b′) if the preset time points of transmission are identical and the CQI signal or the ACK signal is scheduled to be transmitted in the first half of the control channel, transmitting the periodic ranging signal and the bandwidth request ranging signal later than the CQI signal or the ACK signal, and
b″) if the preset time points of transmission are identical and the CQI signal or the ACK signal is scheduled to be transmitted in the second half of the control channel, transmitting the periodic ranging signal and the bandwidth request ranging signal faster than the CQI signal or the ACK signal.

21. (canceled)

22. The method of claim 18, wherein the step a) includes the step of
a′) checking whether the preset time points of transmission of a CQI signal and an ACK signal are identical with the preset time points of transmission of the periodic ranging signal and the bandwidth request ranging signal, and
wherein, at the step b), if the preset time points of transmission of the periodic ranging signal, the bandwidth request ranging signal, the CQI signal and the ACK signal are identical, the preset time point of transmission of the periodic ranging signal is delayed and the preset time point of transmission of the bandwidth request ranging signal is further delayed.

23. (canceled)

24. (canceled)

25. The method of claim 13, wherein the control channel of the uplink frame is comprised of the first symbol duration and the second symbol duration which correspond to three OFDMA symbols respectively and includes a ranging channel region for a ranging signal, a CQI channel region for a CQI signal, and an ACK channel region for an ACK signal; and wherein the CQI channel region and the ACK channel region are allocated in different symbol durations.
